(19) United States
(12) Patent Application Publication
(10) Pub. No.: US 2019/0317617 A1
(43) Pub. Date: Oct. 17, 2019

(54) Terminal Device And Recording Medium

(71) Applicant: FUJITSU CLIENT COMPUTING LIMITED, Kawasaki-shi (JP)

(72) Inventor: Takashi KOGURE, Kawasaki-shi (JP)

(21) Appl. No.: 16/456,428

(22) Filed: Jun. 28, 2019

Related U.S. Application Data
(63) Continuation of application No. PCT/JP2018/006255, filed on Feb. 21, 2018.

(30) Foreign Application Priority Data
Mar. 1, 2017 (JP) 2017-038644

(51) Int. Cl. G06F 3/0354; G06F 3/0488; G06F 3/0484

(52) U.S. Cl. CPC G06F 3/03545; G06F 3/04845; G06F 3/04842; G06F 3/0488

(57) ABSTRACT

A terminal device is provided including a reception unit that receives an operation performed on a window by a hovering stylus pen; an identification unit that, based on a position of the stylus pen and a position of the window when the operation is received, identifies an edge or a corner of the window that is to be an operation target of the stylus pen; and an operation control unit that applies the operation performed by the stylus pen to the identified edge or corner.

### BACKGROUND OF THE INVENTION

### Field of the Invention

The present invention relates to a terminal device and a recording medium.

The present application is a continuation application of PCT International Application No. PCT/JP 2018/006255 filed Feb. 21, 2018, which claims priority from Japanese Patent Application No. 2017-038644, filed Mar. 1, 2017. The entire content of both the above PCT International Application and the above Japanese Patent Application are incorporated herein by reference.

### Description of Related Art

When the size or the like of a window on a screen is to be changed, a pointer is moved to an edge of the window or a corner portion of the window, or the edge or the corner portion is pointed, thereby causing an OS to enter a mode for changing the area of the window. When moving the pointer to an edge of the window or a corner of the window, or pointing the edge or the corner portion, a finger, a mouse or a stylus pen is used. The use of a stylus pen for input enables highly precise operation in comparison to finger operation, but the increasing resolutions of display screens are making the display dot sizes on screens smaller, thus demanding high precision from people performing the operations.

For example, when pointing to a window on a screen with a fingertip, if an edge or a corner of a desired window is included in any portion of the screen that is touched by the finger, then the area that has been pointed to is selected. Additionally, for example, when operating a window on a screen by means of a mouse, if an edge or a corner of the desired window lies on a line of a cursor that is moved together with the movement of the mouse, then that area is selected.

In contrast therewith, a stylus pen has a narrow pen tip, and a specific position on the screen needs to be designated by one point on the pen tip. For this reason, it is difficult to make a stylus pen point correctly at an edge or a corner of the desired window when the stylus pen is in a hovering state.

Therefore, techniques have been disclosed wherein, when at least a portion of an icon is contained in a recognition area including a position in which a hovering operation by a stylus pen has been detected, a “hovering” mark is moved over that icon (see, for example, Japanese Unexamined Patent Application, First Publication No. 2015-215840). Related arts are also disclosed in Japanese Unexamined Patent Application, First Publication Nos. 2010-92419 and 2014-110055.

However, with the hovering stylus pen in Japanese Unexamined Patent Application, First Publication No. 2015-215840, it was difficult to position the tip of the stylus pen with respect to a small portion that presents a target, such as the edge or the corner of a window.

### SUMMARY OF THE INVENTION

Therefore, in one aspect, the present invention has the purpose of allowing a stylus pen to be operated so as to be able to select an edge or a corner of a window even if the edge or the corner of the window is not exactly touched.

In one embodiment, the present invention provides a terminal device including a reception unit that receives an operation performed on a window by a hovering stylus pen; an identification unit that, based on a position of the stylus pen and a position of the window when the operation is received, identifies an edge or a corner of the window that is to be an operation target of the stylus pen; and an operation control unit that applies the operation performed by the stylus pen to the identified edge or corner.

### BRIEF DESCRIPTION OF THE DRAWINGS

FIG. 1 is a diagram showing an example of the hardware structure of a terminal device according to one embodiment.

FIG. 2 is a diagram for explaining a window operation.

FIG. 3 is a diagram showing an example of the functional structure of a terminal device according to one embodiment.

FIG. 4 is a diagram showing an example of a window state management table according to one embodiment.

FIG. 5 is a diagram showing an example of a window state according to one embodiment.

FIG. 6A is a flow chart showing an example of an operation control process according to a first embodiment.

FIG. 6B is a flow chart showing an example of the operation control process according to the first embodiment.

FIGS. 7A-7D constitute a diagram showing an example of window operation according to the first embodiment.

FIG. 8 is a flow chart showing an example of the operation control process according to the first embodiment.

FIG. 9A is a flow chart showing an example of an operation control process according to a second embodiment.

FIG. 9B is a flow chart showing an example of the operation control process according to the second embodiment.

FIG. 10A is a flow chart showing an example of the operation control process according to the second embodiment.

FIG. 10B is a flow chart showing an example of the operation control process according to the second embodiment.

FIG. 11A is a flow chart showing an example of the operation control process according to the second embodiment.

FIG. 11B is a flow chart showing an example of the operation control process according to the second embodiment.

FIG. 12 is a flow chart showing an example of the operation control process according to the second embodiment.

FIGS. 13A-13C constitute a diagram showing examples of operations on adjacent windows according to one embodiment.

### DETAILED DESCRIPTION OF THE INVENTION

Hereinbelow, embodiments of the present invention will be explained by referring to the attached drawings. In the present specification and drawings, structural elements having substantially identical functional structures are labeled with the same reference numbers and redundant descriptions are omitted.

Introduction

In recent years, the number of tablet computers that are shipped has increased. Additionally, terminal devices in which input operations can be performed by using a stylus pen are increasing. Input by means of a stylus pen provides the sensation of writing on real paper, and is thus expected to serve as a replacement for conventional writing implements such as paper and pencils. Additionally, input by means of a stylus pen allows high-precision operation in comparison to input by means of finger touch operations.

However, while finger input does not demand dot-level coordinate precision, input by means of a stylus pen demands dot-level coordinate precision. In particular, due to increases in the resolutions of display screens, screen dot sizes have become smaller, so there is a trend towards requiring higher precision in a stylus pen operation. Thus, it is sometimes difficult to exactly align the pen tip of a stylus pen with a window frame that is thinly displayed on a screen, and to drag the window frame to change the window size to the intended size. Additionally, view differences between the screen and the pen tip, and coordinate deviation due to jitter in the sensor panel can make it difficult to perform window operations by means of a stylus pen.

Thus, the terminal device 10 according to the present embodiment, described below, enables operations allowing the edge or the corner of a window to be selected even when the edge or the corner of the window is not exactly touched by a stylus pen.

In the present specification, “drag” refers to a state in which the pen tip of a stylus pen is brought into contact or nearby so that the stylus pen is in a state of having grabbed an edge or a corner of a window (i.e., a state in which the computer has recognized an edge or a corner that is an operation target of a stylus pen) and making the edge or the corner movable.

Additionally, “view differences between the screen and the pen tip” refers to view differences between the screen and the pen tip that are caused by the method of mounting the sensors for detecting the stylus pen. The “jitter” in the sensor panel refers to time-axis fluctuations in stylus pen operation signals detected by the sensor panel.

Hardware Structure of Terminal Device

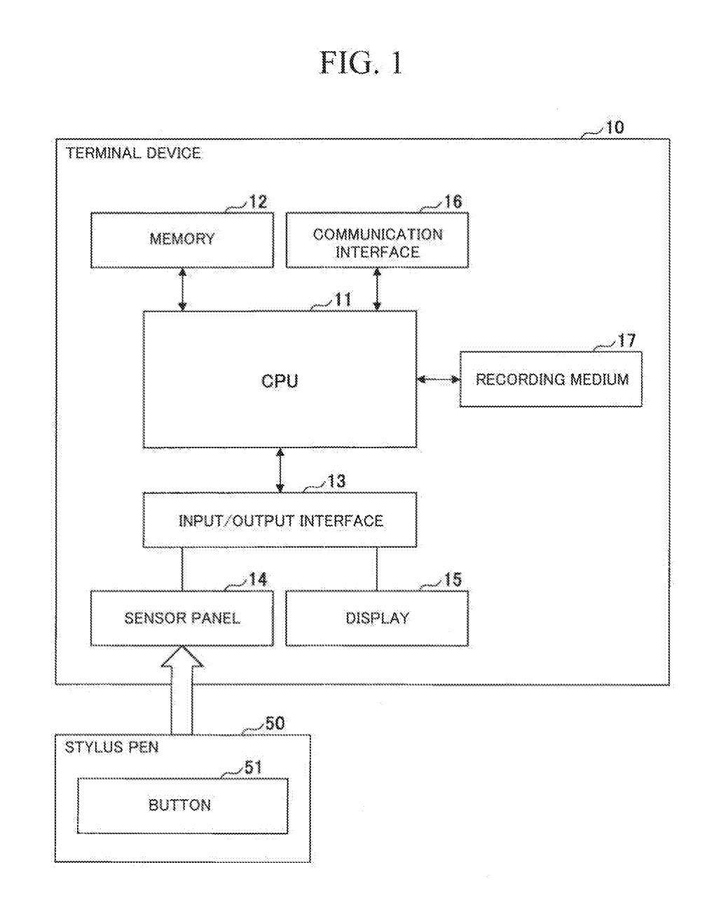

First, an example of the hardware structure of the terminal device 10 according to one embodiment of the present invention will be described with reference to FIG. 1. FIG. 1 shows an example of the hardware structure of a terminal device 10 according to one embodiment.

The terminal device 10 according to the present embodiment includes a CPU 11, a memory 12, an input/output interface 13, a sensor panel 14, a display 15 and a communication interface 16. The CPU 11 controls the terminal device 10 in accordance with a program stored in the memory 12. The memory 12 is, for example, a semiconductor memory, which stores a window operation control program and other programs to be executed by the CPU 11, data referenced by the CPU 11, data acquired as a result of processes executed by the CPU 11, and the like.

The recording medium 17 stores a window operation control program or the like and data or the like, and the CPU 11 may copy the operation control program or the like and data or the like from the recording medium 17 to the memory 12 as needed. Additionally, desired data may be copied from the memory 12 to the recording medium 17 as needed. The recording medium 17 may, for example, be a non-volatile recording medium such as a flash memory.

The sensor panel 14 is laminated onto the display 15 and detects the stylus pen 50 contacting or approaching near the display 15, and a button 51 on the stylus pen 50 being operated. The sensor panel 14 detects the position of the stylus pen 50 on the screen and converts the position to coordinate data. The sensor panel 14 is able to detect the pen tip of the stylus pen 50 even when it is in a state not contacting (being near) the screen, and for example, can detect a pen tip that is at a distance of approximately 1 cm from the screen of the display 15. Hereinbelow, operations on the screen while the stylus pen 50 is kept at a distance of approximately 1 cm from the screen without the pen tip touching the screen will be referred to as “hovering”.

The input/output interface 13 is an interface for inputting coordinate data of the stylus pen 50 detected by the sensor panel 14. Additionally, the input/output interface 13 is an interface for changing the window size in response to an operation by the stylus pen 50, or for outputting the results of processes executed by the CPU 11 to the display 15. The communication interface 16 is an interface that is connected to a network and that communicates with other devices.

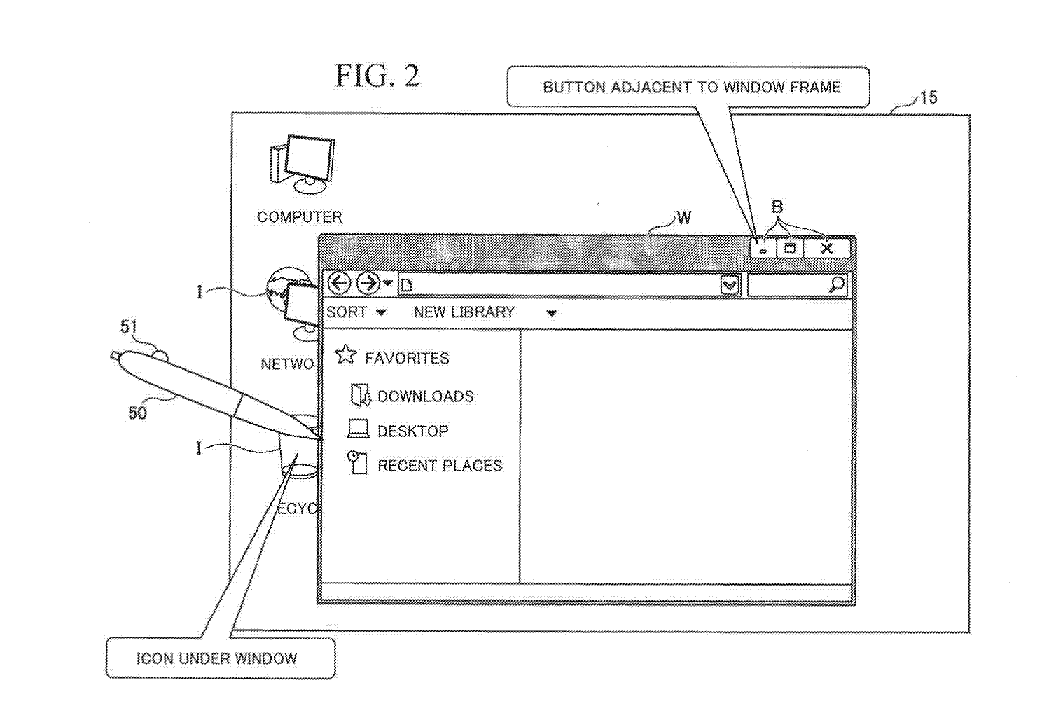

FIG. 2 shows an example of a window display size changing operation using the stylus pen 50. A user brings the pen tip, in a hovering state, near a position on a window frame at one of the four edges (top, bottom, left and right) or one of the four corners (upper left, lower left, upper right and lower right) of a window W whose size is to be changed. In this state, the user presses the button 51 on the stylus pen 50, thereby putting the window W in state for changing the size, and sets the size of the window W by pressing the button 51 once again.

Normally, bringing the pen tip of the stylus pen 50 into contact with the screen would be a “tap” operation, and this tap operation signifies that the window W has been “selected”.

This does not present a problem if only the window W is displayed on the screen. However, if an icon I or a button lies under the left edge of the window W as in FIG. 2, an erroneous operation may occur in which the icon I overlapping with the window W is selected instead of selecting the window W. Additionally, if there are display components such as buttons adjacent to the window frame, as with the buttons B shown at the upper right of the window W in FIG. 2, a tap operation for changing the display size of the window W could cause an adjacent button B to be selected instead of selecting the window W, resulting in an erroneous operation in which the window W is not displayed or the window W is closed.

In contrast therewith, in the present embodiment, the window size W is changed by means of a hovering operation of the stylus pen 50. In a hovering state, a “selection” action will not be registered even in the state of the screen shown in FIG. 2. This is advantageous for ease of operation and, when combined with button operation, can solve the problem of an erroneous operation mentioned above. In other words, there is no need to perform an operation to bring the pen tip of the stylus pen 50 into contact with the screen to drag the window frame, so it is possible to avoid an erroneous operation in which an adjacent icon I or button B is selected when operating the window W.

Therefore, in the present embodiment, a user changes the display size of a window by bringing the pen tip of the stylus pen 50 into a hovering state near a window W whose size is to be changed, and pressing the button 51 on the stylus pen 50. As a result thereof, the stylus pen 50 can be operated so as to allow an edge or a corner of a window W to be selected even if an edge or a corner of the window W is not exactly contacted by the stylus pen 50.

Functional Structure

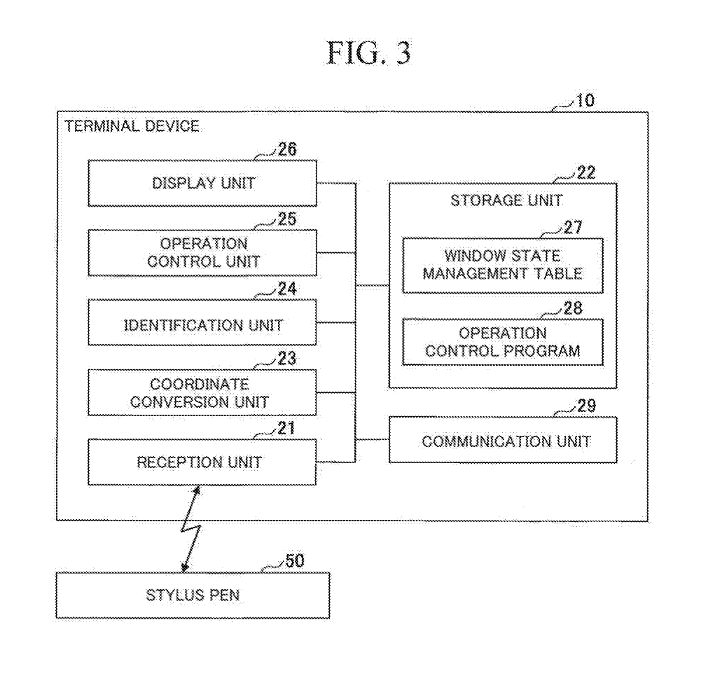

Next, an example of the functional structure of the terminal device 10 according to one embodiment will be described with reference to FIG. 3. FIG. 3 shows an example of the functional structure of a terminal device 10 according to one embodiment. The terminal device 10 according to the present embodiment includes a reception unit 21, a storage unit 22, a coordinate conversion unit 23, an identification unit 24, an operation control unit 25, a display unit 26 and a communication unit 29.

The reception unit 21 receives touches of the pen tip of the stylus pen 50 and operations to the window W by means of a hovering stylus pen 50. The functions of the reception unit 21 may be realized, for example, by the input/output interface 13.

The storage unit 22 stores a window state management table 27 and an operation control program 28. The window state management table 27 is a table for managing the state of a group of windows displayed on the display 15. The window state management table 27 is updated in accordance with the display state of the window W and manages the state of each window. As a result thereof, multi-window management is possible.

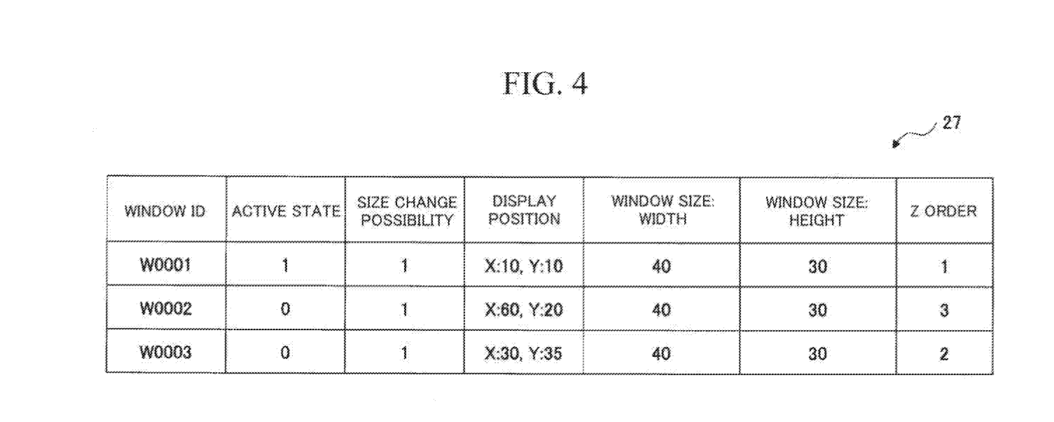

FIG. 4 shows an example of the window state management table 27 according to one embodiment. The window state management table 27 contains window IDs, active state information, size change possibility information, display position information, window size information (width and height) and Z order information.

The window IDs are IDs for identifying windows. The window IDs are assigned by the OS. The active state information is a flag indicating whether a window is in the active state or the inactive state. When the flag has the value “1”, the window is active, and when the value is “0”, the window is inactive.

The size change possibility information is a flag indicating whether or not it is possible to change the display size. When the flag has the value “1”, the display size is changeable, and when the value is “0”, the display size is not changeable. The display size not being changeable means that the window is displayed at a fixed size.

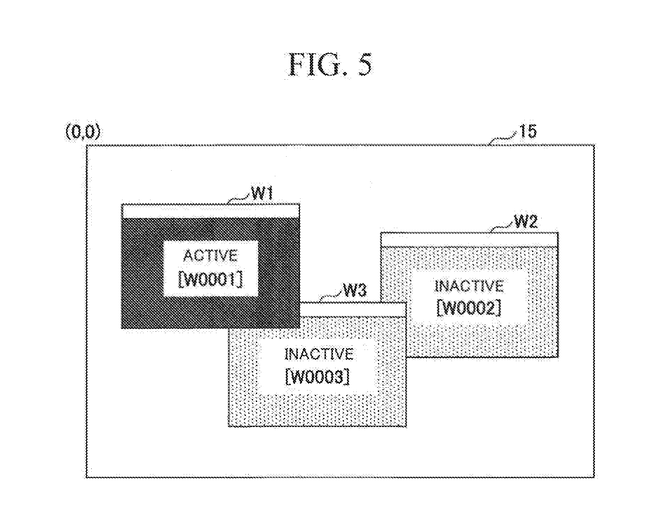

The display position information indicates the coordinates of the upper left of each window in the case in which the origin lies at the upper left (0, 0) of the screen of the display 15 shown as one example in FIG. 5. The window state management table 27 in FIG. 4 manages three windows having the window IDs “W0001”, “W0002” and “W0003”. The coordinates of the upper left of the window “W0001” are (10, 10). The coordinates (X, Y) of the upper left of the window “W0002” are (60, 20). The coordinates of the upper left of the window “W0003” are (30, 35).

As indicated by the active state information in FIG. 4, of the three windows, the window “W0001” is in the active state and the remaining windows are in the inactive state. Additionally, as indicated by the size change possibility information, the sizes of all three windows can be changed.

The window size information indicates the window display size. The display size (width, height) of all three windows is (40, 30).

The Z order information indicates the display order in the depth direction, with the foremost plane having the value “1”. According to the Z order information in FIG. 4, the “W0001”window W1 is displayed foremost, and the “W0003” window W3 and the window “W0002” W2 are displayed in order towards the depth side, as shown in FIG. 5. The information described in the window state management table 27 may be stored in the memory 12, or may be stored in a cloud-based storage device that is connected to the terminal device 10 via a network.

Returning to FIG. 3, the operation control program 28 is a program for making a computer execute a function for changing the window size in accordance with an operation by the stylus pen 50. The function of the storage unit 22 may be realized, for example, by the memory 12.

The coordinate conversion unit 23 converts operations by the stylus pen 50 to coordinate data. The functions of the coordinate conversion unit 23 may be realized, for example, by the sensor panel 14.

The identification unit 24 identifies an edge or a corner of a window that is to be an operation target of the stylus pen 50 based on the position of the stylus pen 50 and the position of the window when an operation to the window by the hovering stylus pen is received. When the position of the stylus pen 50 is near an edge or a corner of the window when an operation to the window is received, the identification unit 24 may identify the nearby edge or corner of the window as the edge or corner of the window that is to be the operation target by the stylus pen 50.

The operation control unit 25 applies the operation of the stylus pen 50 to the identified edge or corner. For example, the operation control unit 25 applies the change in the relative position of the window W indicated by the stylus pen 50, before and after the operation to the window W, to the edge or the corner identified by the hovering of the stylus pen 50. As a result thereof, the window size can be changed as desired with the stylus pen 50 in a hovering state. The functions of the identification unit 24 and the operation control unit 25 may be realized by processes that the operation control program 28 makes the CPU 11 perform.

The display unit 26 displays the window W with the size changed in accordance with the hovering operation of the stylus pen 50. The functions of the display unit 26 may be realized, for example, by the display 15. The communication unit 29 exchanges information between the terminal device 10 and other devices via a network. The functions of the communication unit 29 may be realized, for example, by the communication interface 16.

FIG. 3 illustrates a block diagram that focuses on the functions, and a processor that runs software for the respective parts indicated by these functional blocks is hardware.

### First Embodiment

Operation Control Process

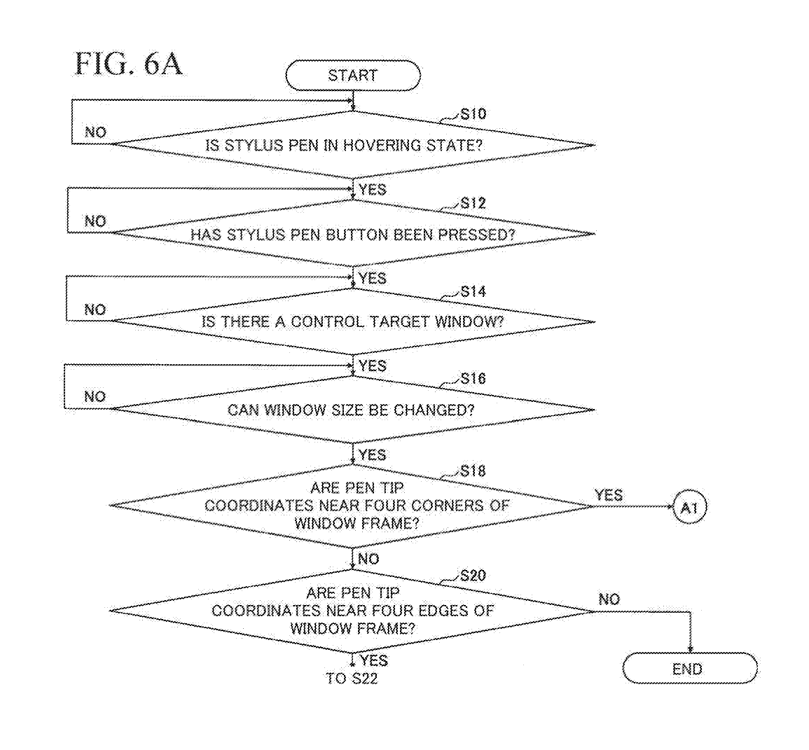

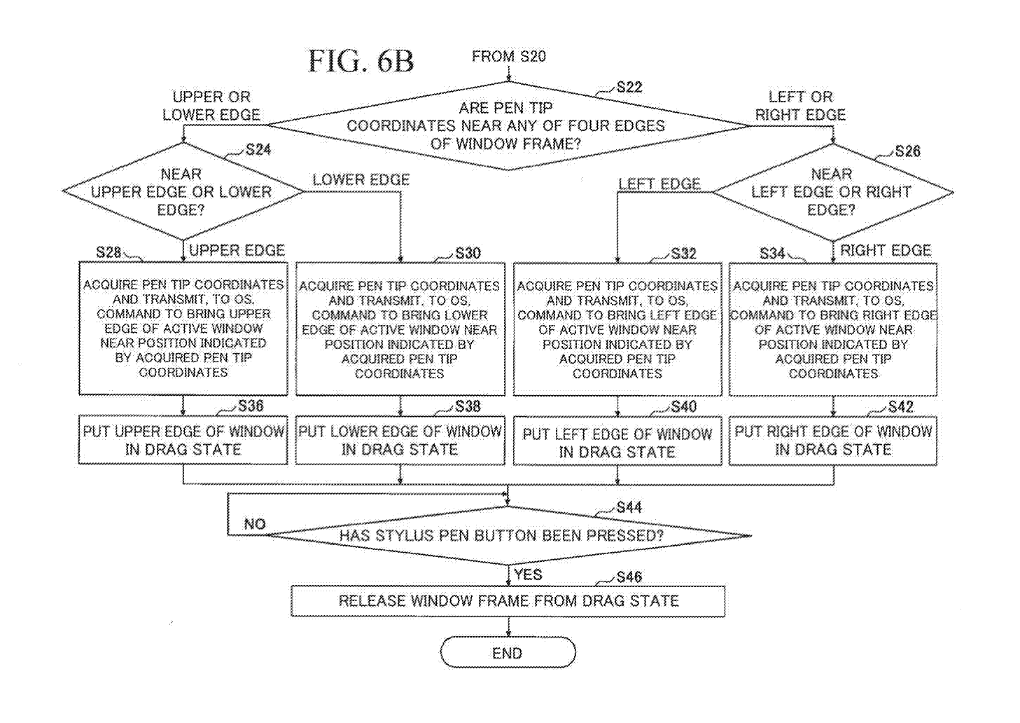

Next, an example of the operation control process according to the first embodiment will be explained with reference to FIG. 6A and FIG. 6B. FIG. 6A and FIG. 6B are flow charts showing an example of an operation control process according to the first embodiment. When the main process in FIG. 6A is started, the reception unit 21 determines whether the stylus pen 50 is in the hovering state (step S10). The reception unit 21 repeats step S10 until the stylus pen 50 enters the hovering state.

When it is determined that the stylus pen 50 is in the hovering state, the reception unit 21 determines whether or not the button 51 on the stylus pen 50 has been pressed (step S12). The reception unit 21 repeats step S12 until the button 51 on the stylus pen 50 is pressed.

When it is determined that the button 51 on the stylus pen 50 has been pressed, the identification unit 24 determines whether or not there is a window that may be a control target (step S14). The identification unit 24 refers to the window state management table 27, and if there is no active window, then it determines that there is no window that may be a control target, and step S14 is repeated.

When there is an active window, the identification unit 24 determines that there is a window that may be a control target, and determines whether or not the size of that window can be changed (step S16). The identification unit 24 refers to the window state management table 27 and, if it is determined that the value of the size change possibility information flag of the control target window is not “1”, repeats the step S16 until the value of the size change possibility information of the control target window becomes “1”.

If it is determined that the value of the size change possibility information of the control target window is “1”, then the identification unit 24 determines whether the coordinates of the pen tip of the stylus pen 50 are near the four corners of the window frame (step S18). The coordinates of the pen tip of the stylus pen 50 are calculated by the coordinate conversion unit 23. Thus, the identification unit 24 can determine whether or not the coordinates of the pen tip are near the four corners of the window frame based on the calculated coordinates of the pen tip and the information regarding the window size and the display position of the control target window stored in the window state management table 27.

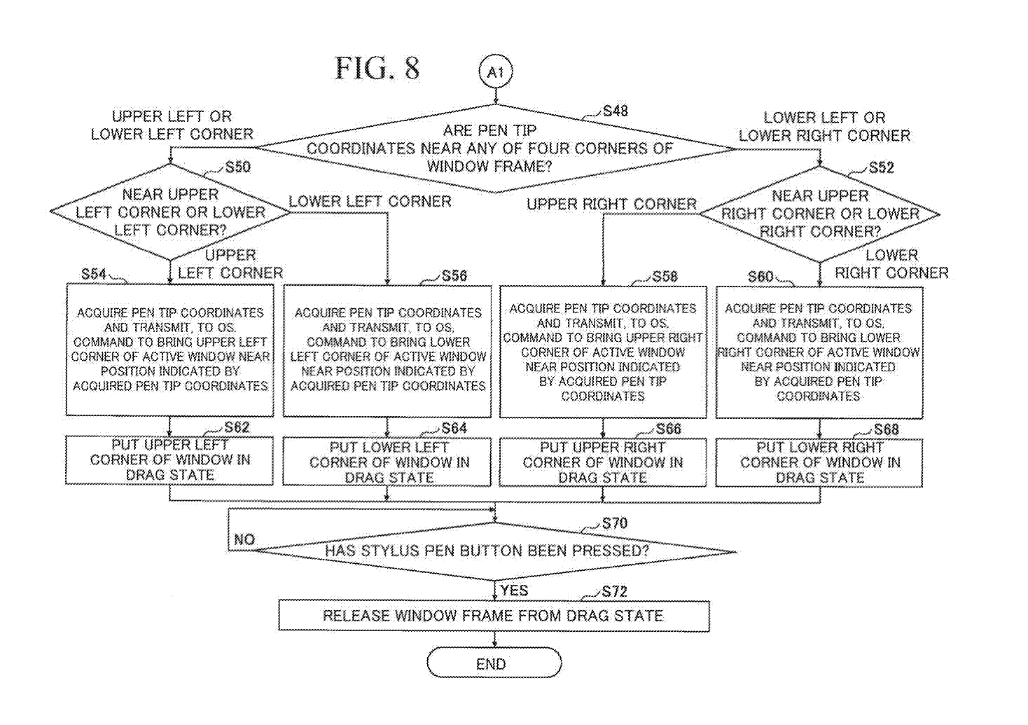

If it is determined that the coordinates of the pen tip are near the four corners of the window frame, then the procedure starting at A1 in FIG. 8 is executed. The procedure starting at A1 in FIG. 8 will be discussed below. On the other hand, if it is determined, in step S18, that the coordinates of the pen tip are not near the four corners of the window frame, then the identification unit 24 determines whether the coordinates of the pen tip of the stylus pen 50 are near the four edges of the window frame (step S20). If it is determined that the coordinates of the pen tip are not near the four edges of the window frame, then the present procedure ends.

On the other hand, if it is determined, in step S20, that the coordinates of the pen tip are near the four edges of the window frame, then the identification unit 24 determines which of the four edges of the window frame the coordinates of the pen tip are near, as shown in FIG. 6B (step S22). If it is determined that, among the four edges of the window frame, the coordinates of the pen tip are near either the upper edge or the lower edge, then the identification unit 24 determines whether they are near the upper edge or near the lower edge (step S24). If it is determined that they are near the upper edge, then the identification unit 24 acquires the coordinates of the pen tip and transmits, to the OS, a command to change the window size of the active window W by bringing the upper edge closer to the position indicated by the acquired coordinates of the pen tip (step S28). Next, the operation control unit 25 puts the upper edge of the window in a drag state (step S36).

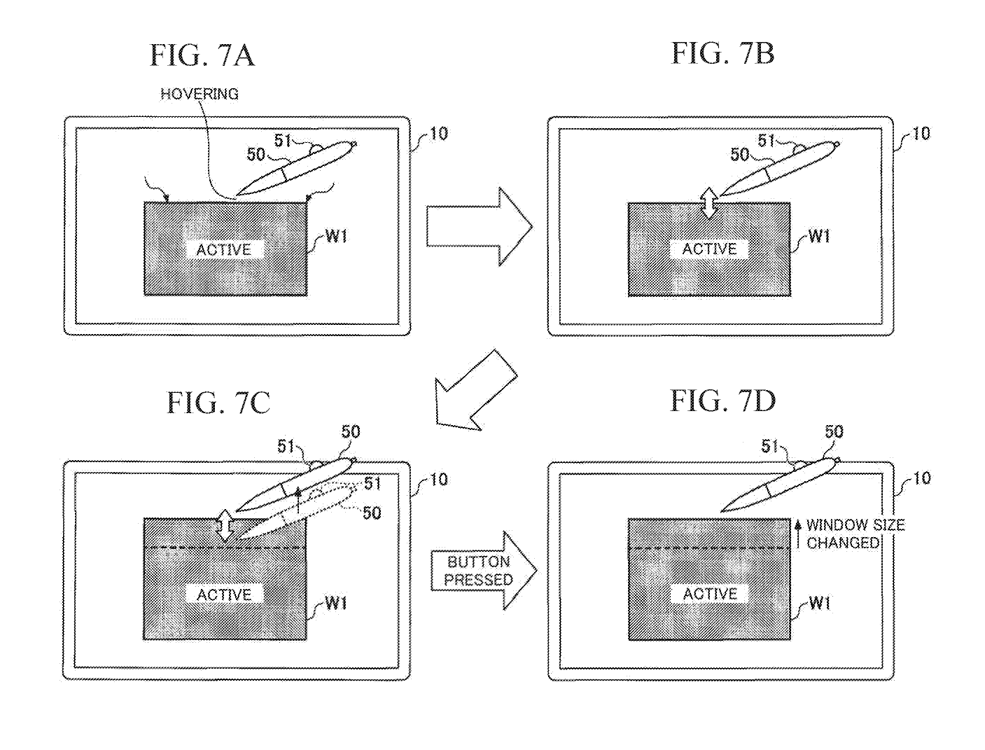

For example, in FIG. 7A, the pen tip of the stylus pen 50 is in a hovering state near the upper edge of the active window W1 which is the control target. If the acquired coordinates of the pen tip indicate a position above the upper edge of the active window W, then a command is transmitted, to the OS, to change the window size of the active window W1 by bringing the upper edge closer to the position indicated by the acquired coordinates of the pen tip. As a result thereof, the upper edge of the active window W1 is put in a drag state, as shown in FIG. 7B. In this case, an arrow mark indicating that the edge is in the drag state is displayed, so that it can be understood that the upper edge of the active window W1 has been put in the drag state.

Returning to FIG. 6B, next, the operation control unit 25 determines whether the button 51 on the stylus pen 50 has been pressed (step S44). The operation control unit 25 repeatedly executes the process in step S44 until the button 51 on the stylus pen 50 is pressed and, if it is determined that the button 51 on the stylus pen 50 has been pressed, releases the window frame from the drag state (step S46), and the present procedure ends.

For example, suppose that, with the upper edge of the active window W1 in FIG. 7B in the drag state, the user moves it further upward while hovering the stylus pen 50 and presses the button 51 at a certain position, as shown in FIG. 7C. In this case, the relative position change before and after the operation to the window, as indicated by the stylus pen 50, is applied to the identified edge (here, the upper edge) and the window size is changed, as shown in FIG. 7D. Furthermore, the arrow mark indicating that the upper edge of the window W1 is in the drag state is no longer displayed and the window is released from the drag state.

Thus, by operating the button 51 while the stylus pen 50 is in the hovering state, it is possible to operate a nearby window W, not only when the position of the stylus pen is directly above an edge or a corner of the window when the operation is received, but also even when it is not directly above an edge or a corner of the window, as long as it is near the window. Furthermore, the size of the window W can be changed with the stylus pen 50 in the hovering state.

Returning to FIG. 6B, on the other hand, if it is determined, in steps S22 and S24, that the coordinates of the pen tip are near the lower edge among the four edges of the window frame, then the identification unit 24 acquires the coordinates of the pen tip and transmits, to the OS, a command to change the window size of the active window W by bringing the lower edge closer to the position indicated by the acquired coordinates of the pen tip (step S30). Next, the operation control unit 25 puts the lower edge of the window in the drag state (step S38). The operation control unit 25 repeatedly executes the process in step S44 until the button 51 on the stylus pen 50 is pressed, and when the button 51 is pressed, the window frame is released from the drag state (step S46) and the present procedure ends.

Similarly, if it is determined, in step S22, that the coordinates of the pen tip are near either the left edge or the right edge among the four edges of the window frame, then the identification unit 24 determines whether they are near the left edge or near the right edge (step S26). If it is determined that the coordinates are near the left edge, then the identification unit 24 acquires the coordinates of the pen tip and transmits, to the OS, a command to change the window size of the active window W by bringing the left edge closer to the position indicated by the acquired coordinates of the pen tip (step S32). Next, the operation control unit 25 puts the left edge of the window in the drag state (step S40).

The operation control unit 25 repeatedly executes the process in step S44 until the button 51 on the stylus pen 50 is pressed, and when the button 51 is pressed, the window frame is released from the drag state (step S46) and the present procedure ends.

Similarly, if it is determined, in step S26, that the coordinates of the pen tip are near the right edge among the four edges of the window frame, then the identification unit 24 acquires the coordinates of the pen tip and transmits, to the OS, a command to change the window size of the active window W by bringing the right edge closer to the position indicated by the acquired coordinates of the pen tip (step S34). Next, the operation control unit 25 puts the right edge of the window in the drag state (step S42), and when the button 51 on the stylus pen 50 is pressed (step S44), releases the window frame from the drag state (step S46), and the present procedure ends.

The case in which it is determined, in step S18, that the coordinates of the pen tip are near the four corners of the window frame and the procedure advances to the procedure starting at Al in FIG. 8 will be explained. The identification unit 24 determines which of the four corners of the window frame the coordinates of the pen tip are near (step S48).

If it is determined that, among the four corners of the window frame, the coordinates of the pen tip are near either the upper left corner or the lower left corner, then the identification unit 24 determines whether they are near the upper left corner or near the lower left corner (step S50). If it is determined that they are near the upper left corner, then the identification unit 24 acquires the coordinates of the pen tip and transmits, to the OS, a command to change the window size of the active window W by bringing the upper left corner closer to the position indicated by the acquired coordinates of the pen tip (step S54).

Next, the operation control unit 25 puts the upper left corner of the window in the drag state (step S62). The operation control unit 25 repeatedly executes the process in step S70 until the button 51 on the stylus pen 50 is pressed and, if it is determined that the button 51 on the stylus pen 50 has been pressed, releases the window frame from the drag state (step S72), and the present procedure ends.

If it is determined, in step S50, that the coordinates of the pen tip are near the lower left corner, then the identification unit 24 acquires the coordinates of the pen tip and transmits, to the OS, a command to change the window size of the active window W by bringing the lower left corner closer to the position indicated by the acquired coordinates of the pen tip (step S56). Next, the operation control unit 25 puts the lower left corner of the window in the drag state (step S64). The operation control unit 25 repeatedly executes the process in step S70 until the button 51 on the stylus pen 50 is pressed and, if it is determined that the button 51 on the stylus pen 50 has been pressed, releases the window frame from the drag state (step S72), and the present procedure ends.

On the other hand, if it is determined, in step S48, that the coordinates of the pen tip are near either the upper right corner or the lower right corner among the four corners of the window frame, then the identification unit 24 determines whether they are near the upper right corner or near the lower right corner (step S52).

If it is determined, in step S52, that the coordinates of the pen tip are near the upper right corner, then the identification unit 24 acquires the coordinates of the pen tip and transmits, to the OS, a command to change the window size of the active window W by bringing the upper right corner closer to the position indicated by the acquired coordinates of the pen tip (step S58). Next, the operation control unit 25 puts the upper right corner of the window in the drag state (step S66). The operation control unit 25 repeatedly executes the process in step S70 until the button 51 on the stylus pen 50 is pressed and, if it is determined that the button 51 on the stylus pen 50 has been pressed, releases the window frame from the drag state (step S72), and the present procedure ends.

On the other hand, if it is determined, in step S52, that the coordinates of the pen tip are near the lower right corner, then the identification unit 24 acquires the coordinates of the pen tip and transmits, to the OS, a command to change the window size of the active window W by bringing the lower right corner closer to the position indicated by the acquired coordinates of the pen tip (step S60). Next, the operation control unit 25 puts the lower right corner of the window in the drag state (step S68). The operation control unit 25 repeatedly executes the process in step S70 until the button 51 on the stylus pen 50 is pressed and, if it is determined that the button 51 on the stylus pen 50 has been pressed, releases the window frame from the drag state (step S72), and the present procedure ends.

In the case of finger operation, dot-level precision is unnecessary. However, there are cases in which the window that is the operation target is displayed adjacent to a display component used for another type of control, such as an icon I or a button B for closing the window (see FIG. 2). In this case, finger operations may result in an erroneous operation as mentioned above.

In contrast therewith, as explained above, with the operation control process by the terminal device 10 according to the present embodiment, operations are performed by hovering the stylus pen 50. As a result thereof, there are no erroneous operations even in display environments in which display components such as buttons B for closing the window are adjacent to the window. When the button 51 on the stylus pen 50 is pressed, the operations are limited to those for controlling the window frame, so erroneous operations do not occur. Thus, with the operation control processes according to the present embodiment, the stylus pen 50 can be operated so as to allow an edge or a corner of a window W to be selected even if the edge or the corner of the window W is not exactly contacted. This facilitates the positioning of the tip of a hovering stylus pen 50 with respect to a portion that presents a small target, such as an edge or a corner of a window W.

In order to determine whether or not the coordinates of the pen tip of the stylus pen 50 are near the four edges or the four corners of a window frame, strip-shaped ranges within, for example, 1 cm with respect to the screen display, from an origin on the display frame of the window, may be defined as the range of nearness to the four edges or the four corners of the window frame. However, the range need not be limited to strip-shaped ranges within 1 cm, and they may be strip-shaped ranges of several centimeters or strip-shaped ranges of a few millimeters. In other words, an area within the range of a few millimeters to several centimeters with respect to the screen display, from origins on the window display frame, may be defined as being near the four edges or the four corners of the window frame. Alternatively, based on the window size, a distance within a certain ratio from the position of the window frame may be considered to be near. As one example, a range up to a position in which the length of a window is extended by 10%, in the same axial direction, from the window frame may be considered to be near.

In other words, when a pen tip position is detected within the above-mentioned pixel range relative to the window frame, a window frame on which the pen tip position has been detected is considered to be a size change target based on the control conditions.

The invention is not limited to the subject matter explained in connection with the first embodiment. If it is determined that the stylus pen is on the upper side, the lower side, the left side, the right side or the like with respect to an identified edge or corner, then it is possible to bring the identified edge or corner from the current position closer to a position indicated by the coordinates of the pen tip of the stylus pen when or before a drag operation by the stylus pen is received. Additionally, instead of automatically performing an action for moving an identified edge or corner from the current position closer to the position indicated by the coordinates of the pen tip of a stylus pen, it is possible to move the identified edge or corner from the current position closer to the position indicated by the coordinates of the pen tip of the stylus pen upon receiving a prescribed operation, such as the pressing of a button on the stylus pen, after the edge or corner has been identified. When doing so, if the upper edge is to be moved upward, the window size may be stretched upward, or the position of the window may be moved without changing the window size (for example, by moving the entire window upward).

### Second Embodiment

Operation control process

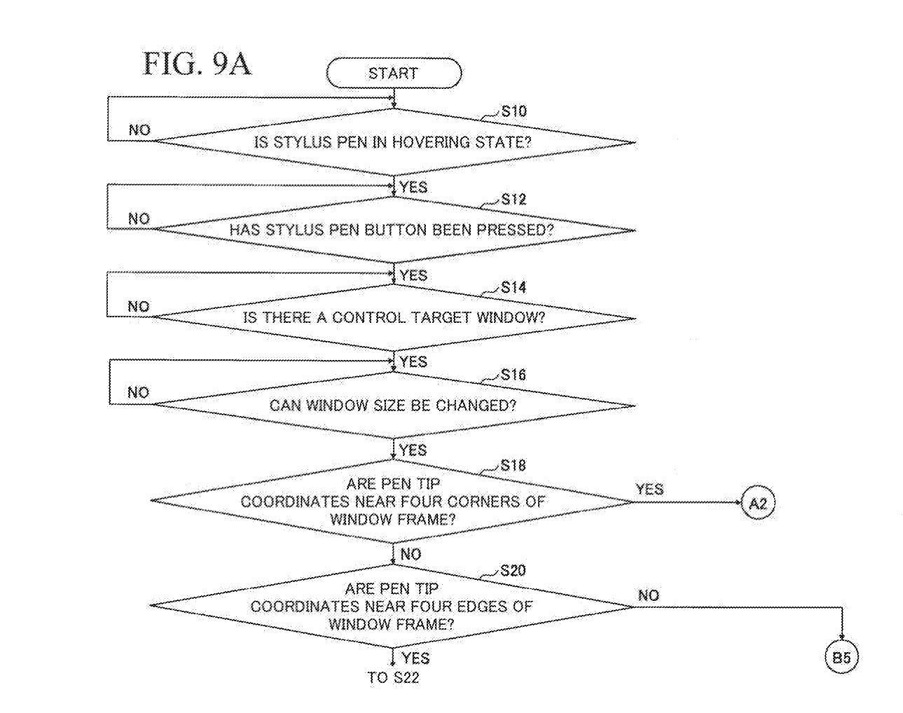

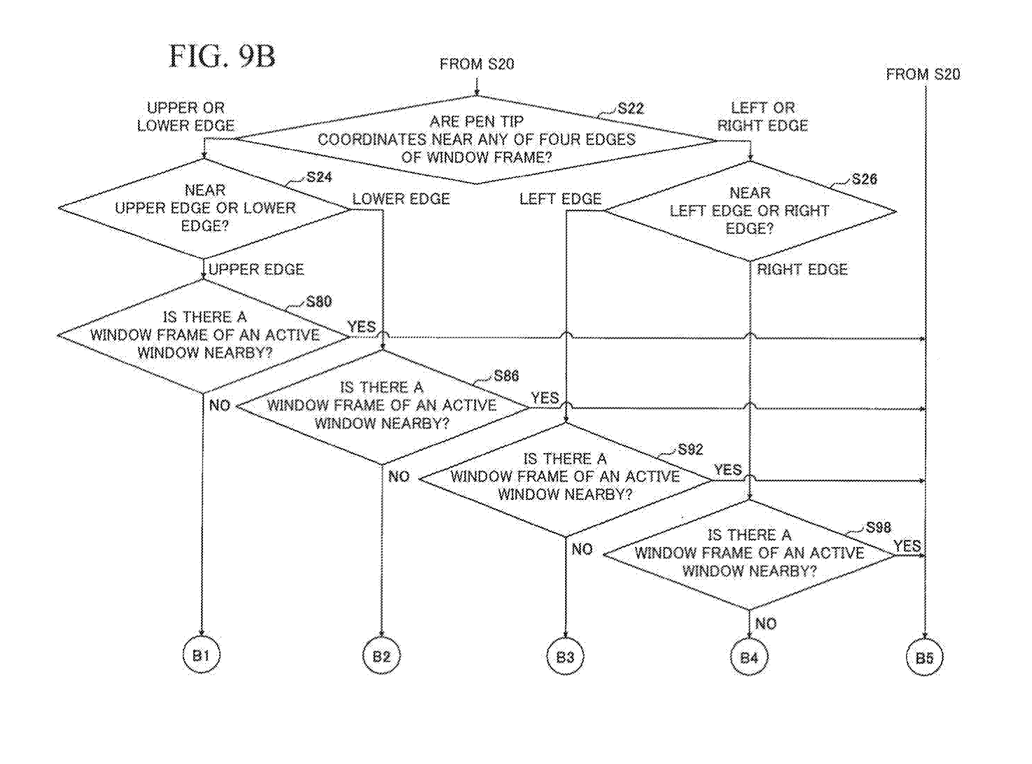

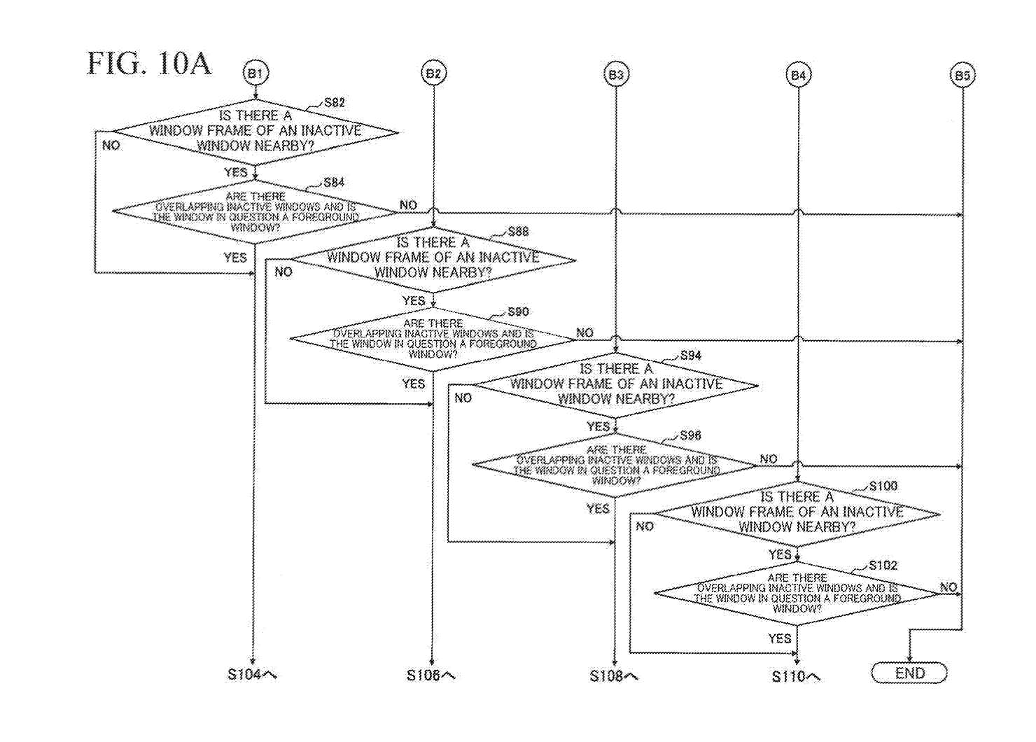

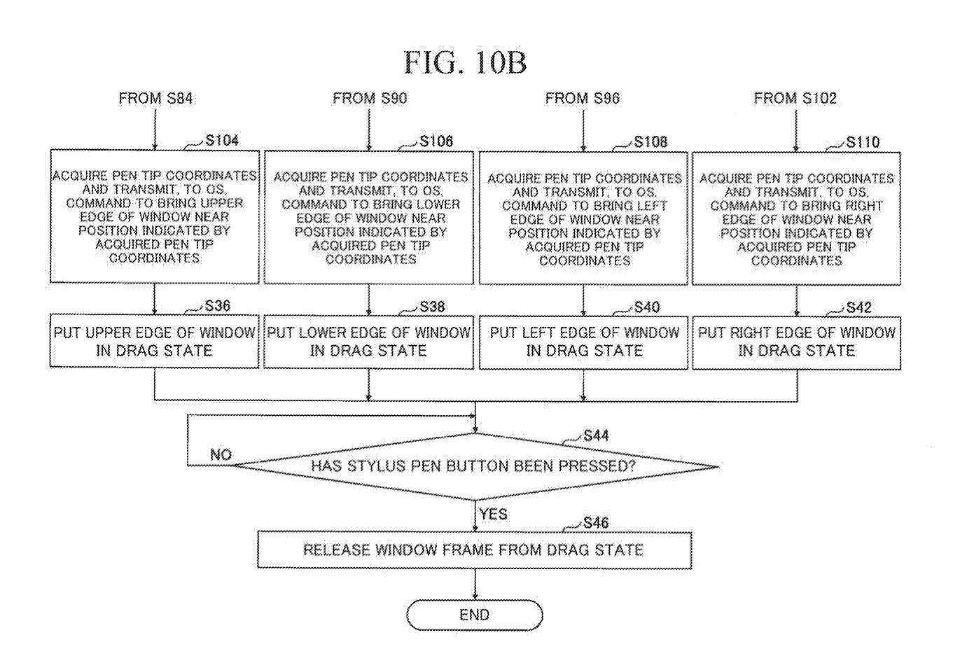

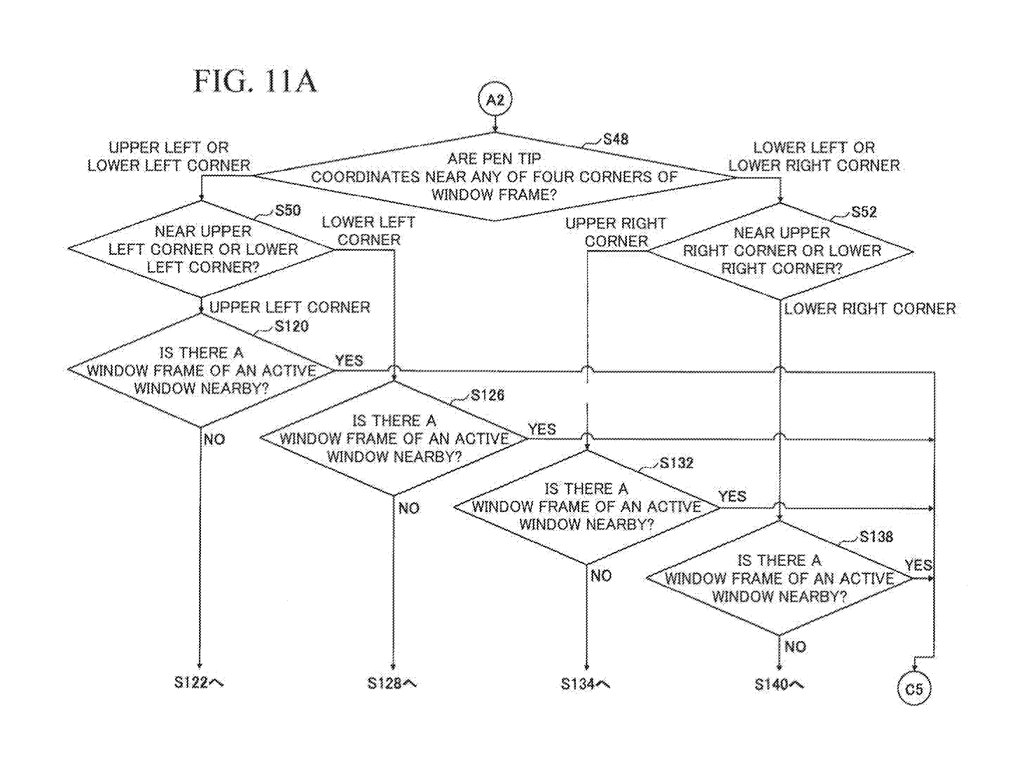

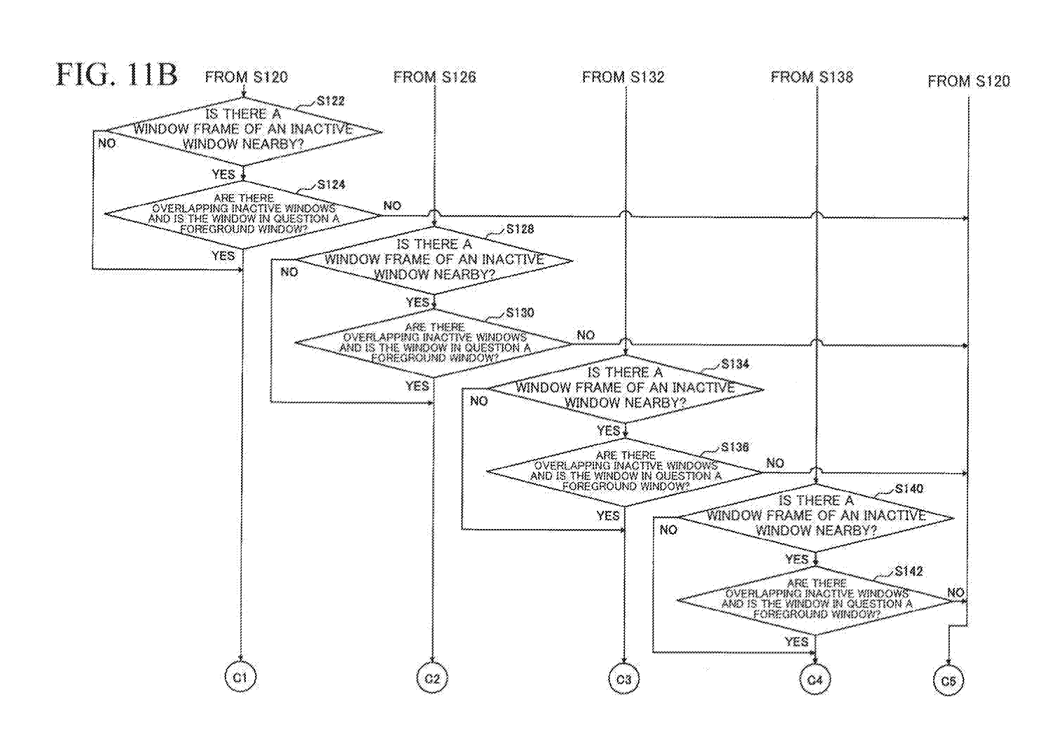

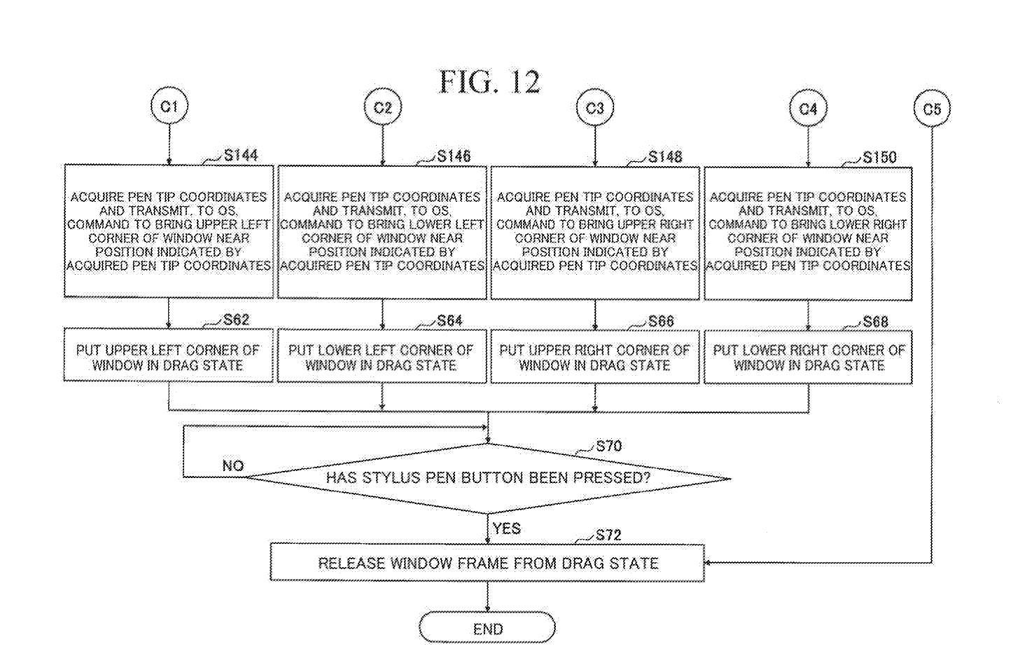

Next, an example of an operation control process according to the second embodiment will be explained with reference to FIG. 9A and FIG. 9B, FIG. 10A and FIG. 10B, FIG. 11A and FIG. 11B, and FIG. 12. FIG. 9A and FIG. 9B, FIG. 10A and FIG. 10B, FIG. 11A and FIG. 11B, and FIG. 12 are flow charts indicating examples of operation control processes according to the second embodiment. Regarding the steps in which processes identical to the operation control processes in the first embodiment are performed, the explanations will be omitted or simplified by appending the same step numbers.

The processes in steps S10 to S26 in FIG. 9A and FIG. 9B in the present procedure are the same as those in the first embodiment (see FIG. 6A and FIG. 6B), so their explanations will be omitted and the explanation will begin from the procedure at step S80 in FIG. 9B. When it is determined that the coordinates of the pen tip of the stylus pen 50 are at an upper edge among the four edges of a window frame, the identification unit 24 determines whether or not there is a window frame of an active window nearby (step S80). If there is a window frame of an active window nearby, then the present procedure ends, the operation control process of the first embodiment (FIG. 6A, FIG. 6B and FIG. 8) is executed, and operation control is performed with respect to the active window.

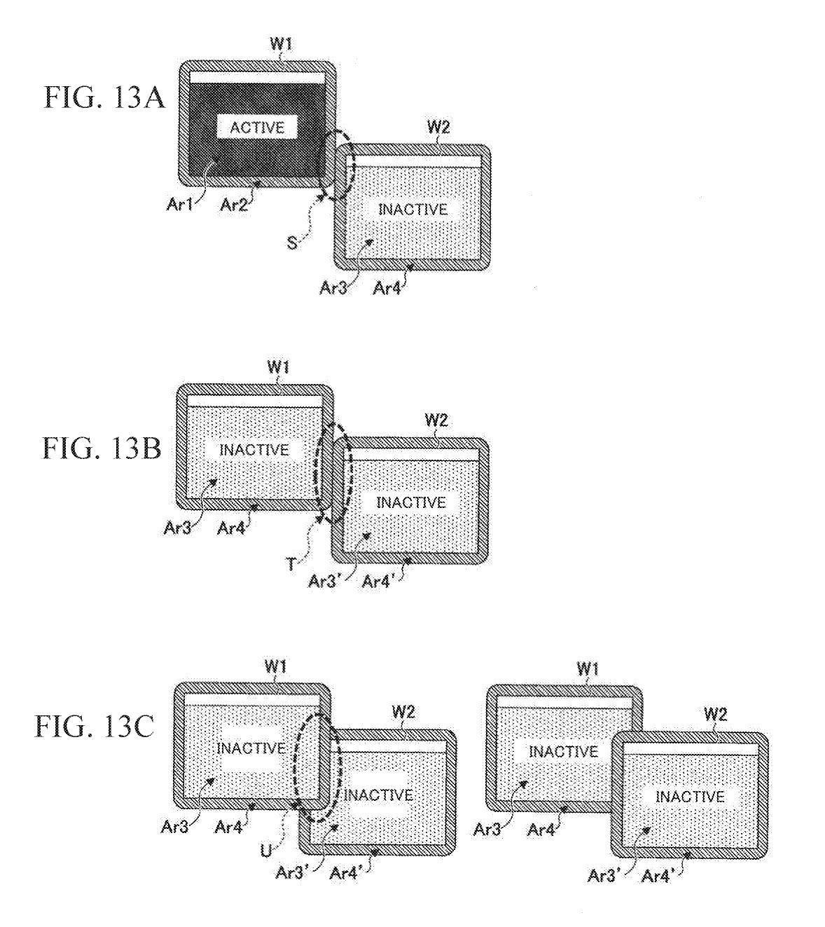

If the frame recognition areas of two windows W1 and W2 overlap as shown, for example, in FIG. 13A, then the operations to the active window W1 are preferred in the overlapping portion, but it is still possible to change the size of the inactive window W2 at non-overlapping edges and corners (portions other than the area S).

The area Ar1 (inside the area Ar2) in FIG. 13A is the active window area, and the area Ar2 is the frame recognition area of the active window. The area Ar3 (inside the area Ar4) is the inactive window area, and the area Ar4 is the frame recognition area of the inactive window.

A “frame recognition area” is defined as a strip-shaped range within, for example, 1 cm with respect to the screen display, from an origin on the display frame of a window. When the physical screen size is 12.5 inches and this is converted to pixels, the size, for different resolutions, is as follows:
FHD resolution: 69 pixels
HD resolution: 46 pixels
4K resolution: 139 pixels

In other words, when the pen tip position is detected within the above-mentioned pixel ranges with respect to a window frame, the window frame at which the pen tip position was detected is recognized as a size change target based on control conditions. However, the “frame recognition area” need not be limited to being a strip-shaped range within 1 cm, and may be a strip-shaped range within a few millimeters to several centimeters.

Returning to FIG. 9B, if a window frame of an active window does not lie nearby in step S80, then the identification unit 24 advances to B1 in FIG. 10A and determines whether or not there is a window frame of an inactive window nearby (step S82). If a window frame of an inactive window does not lie nearby in step S82, then the procedure advances to step S104. If there is a window frame of an inactive window nearby, then the identification unit 24 determines whether there are multiple overlapping inactive windows and whether or not the window in question is a window in the foreground (step S84). If there are multiple overlapping inactive windows and the window in question is a window in the foreground, then the procedure advances to step S104. Otherwise, the present procedure ends.

For example, if there are two inactive windows overlapping, in the case of the window W1 on the left in FIG. 13C, it is the window in the foreground, so a “Yes” is returned and the procedure advances to step S104.

Next, in step S104 in FIG. 10B, the identification unit 24 acquires the coordinates of the pen tip. The operation control unit 25 transmits, to the OS, a command to change the size of the inactive window W by moving the upper edge in a direction indicated by the acquired coordinates of the pen tip. Next, the operation control unit 25 puts the upper edge of the window in the drag state (step S36). The processes in steps S44 and S46 are the same as the operation control processes in the first embodiment, so their explanations will be omitted. As a result, the inactive window can be changed to an active window by means of the OS, making it possible to move the window to a portion to which it is dragged.

The areas Ar3, Ar3′ (inside the areas Ar4 and Ar4′) in FIG. 13B and FIG. 13C are inactive window areas, and the areas Ar4 and Ar4′ are frame recognition areas of the inactive windows. The case in which there are “multiple overlapping inactive windows” in steps S84, S90, S96 and S102 is a case in which the frame recognition areas Ar4 and Ar4′ of the two inactive windows are touching or overlapping, or a case in which the inactive window areas Ar3 and Ar3′ are overlapping.

If the frame recognition areas of two inactive windows are touching as shown in FIG. 13B (the portion of area T), this is a situation in which two inactive windows are overlapping, so the windows cannot be controlled. However, the sizes of the windows can be changed at the non-overlapping edges and corners (portions other than area T).

If two inactive window areas are overlapping as shown in FIG. 13C, then the operations to the window positioned in the foreground are preferred, but it is still possible to change the size of the window lying in the background at the non-overlapping edges and corners. For example, in the state on the left in FIG. 13C, two inactive window areas Ar3 and Ar3′ are overlapping, and in the case of the window W2, it is the window in the background, so the size of the window cannot be changed. In the case of window W1, it is the window in the foreground, so the size of the window can be changed. However, the sizes of the windows can be changed at the non-overlapping edges and corners (portions other than area U). In the state on the right in FIG. 13C, the overlap of the windows W1 and W2 is reversed, so the operations to the window W1 are restricted in the overlapping portion. Thus, in a state in which there are two overlapping inactive windows, the operations to the background window are restricted in the overlapping portion, while the operations to the foreground window are possible even in the overlapping portion.

In the processes of steps S80 to S84, 5104 and S36 in FIG. 9b, FIG. 10A and FIG. 10B explained above, the case in which the pen tip is near the upper edge among the four edges of the window frame was explained. In comparison therewith, the processes of steps S86 to S90, S106 and S38 are for the case in which the pen tip is near the lower edge among the four edges of the window frame. Only the operation target is different and the control details are the same as the processes in steps S80 to S84, 5104 and S36, so the explanation will be omitted. Similarly, steps S92 to S96, S108 and S40 are processes for the case in which the pen tip is near the left edge among the four edges of the window frame. Additionally, steps S98 to S102, S110 and S42 are processes for the case in which the pen tip is near the right edge among the four edges of the window frame. In these processes, only the operation target is different and the control details are the same as the processes in steps S80 to S84, 5104 and S36, so the explanation will be omitted.

Thus, even in the case of an inactive window, a stylus pen can be operated so as to be able to select an edge or a corner of a window W even if an edge or a corner of the window is not exactly contacted. Additionally, if there are overlapping window areas or if there are overlapping frame recognition areas of windows, it is possible to identify a window that is to be preferentially operated based on multiple set conditions, and to perform preferential processes for the identified window. Additionally, it is possible to allow the sizes of windows to be changed at non-overlapping edges and corners.

Next, the procedure from A2 in FIG. 11A for the case in which it is determined, in step S18 in FIG. 9A, that the coordinates of a pen tip are near one of the four corners of the window frame will be explained. The identification unit 24 determines which of the four corners of the window frame the coordinates of the pen tip are near (step S48). If the identification unit 24 determines, in step S48 and step S50, that the coordinates of the pen tip are near the upper left corner, then the identification unit 24 determines whether or not there is a window frame of an active window nearby (step S120). If there is a window frame of an active window nearby, then the present procedure ends, the operation control process of the first embodiment (FIG. 6A, FIG. 6B and FIG. 8) is executed, and operation control is performed with respect to the active window.

On the other hand, if a window frame of an active window does not lie nearby in step S120, then the procedure advances to step S122 in FIG. 11B, and the identification unit 24 determines whether or not there is a window frame of an inactive window nearby. If there is a window frame of an inactive window nearby, then the identification unit 24 determines whether this is a case in which the frame recognition areas of two inactive windows overlap, and the window in question is a foreground window (step S124).

If there are two inactive windows overlapping and the window in question is a background window, then the present procedure ends (from C5 in FIG. 11B to the end in FIG. 12). If there are two inactive windows overlapping and the window in question is a foreground window, then the procedure advances to step S144 in FIG. 12. Additionally, the procedure also advances to step S144 in FIG. 12 if a window frame of an inactive window does not lie nearby in step S122.

In step S144, the identification unit 24 acquires the coordinates of the pen tip. The operation control unit 25 transmits, to the OS, a command to change the size of the inactive window W by moving the upper left corner in a direction indicated by the acquired coordinates of the pen tip. Next, the operation control unit 25 puts the upper left corner of the window in the drag state (step S62). The processes in steps S70 and S72 are the same as the operation control processes in the first embodiment, so their explanations will be omitted.

In the processes of steps S120 to S124, S144 and S62 in FIG. 11A, FIG. 11B and FIG. 12 explained above, the case in which the pen tip is near the upper left corner among the four corners of the window frame was explained. The processes of steps S126 to S130, S146 and S64 are for operation control in the case in which the pen tip is near the lower left corner of the window frame. The control details are the same as the processes in steps S120 to S124, S144 and S62, so their explanations will be omitted.

Similarly, the same operations are performed as the processes in steps S132 to S136, S148 and S66 for the case in which the pen tip is near the upper right corner of the window frame, and the processes in steps S138 to S142, S150 and S68 for the case in which the pen tip is near the lower right corner of the window frame, so their explanations will be omitted.

According to the operation control processes in the second embodiment, a stylus pen 50 can be operated so as to select an edge or a corner of a window even if the edge or the corner of the window is not exactly contacted. This facilitates the positioning of the tip of a hovering stylus pen 50 with respect to a portion that presents a small target, such as an edge or a corner of a window W.

Furthermore, in the second embodiment, it is possible to change an inactive window to an active window by means of the OS, allowing the window to be moved to a portion to which it is dragged.

Specifically, when two or more windows are displayed on the screen, if the size of an inactive window is to be changed, the window for which the window size is to be controlled can be identified by the positional relationship with respect to an active window (FIGS. 13A-C).

If the positional relationship between two or more windows is such that they are in a separated state, then a “No” is returned, for example, in steps S82, S88, S94 or 5100 in FIG. 10A or the like, and it becomes possible to change the size of the window at the four edges and the four corners. When an edge of an active window or a corner of a window is adjacent to or overlaps a window that is a control target, the control of the active widow is preferred. In this case, it is possible to change the size of the inactive window only at edges or corners away from the active window. Regarding the control conditions for window size changes based on the positional relationship between inactive windows, size changes are preferred in foreground windows over background windows.

While a terminal device and an operation control program have been explained by means of the embodiments above, the terminal device and the operation control program in the present invention are not restricted to the above-described embodiments, and various modifications and improvements are possible within the range of the present invention. Additionally, when there are multiple embodiments and modified examples, they can be combined within a range not contradicting each other.

The terminal device 10 of the present invention may be applied to all kinds of electronic devices, such as tablet computers, personal computers, smartphones, PDAs (Personal Digital Assistants), mobile telephones, music playback devices, portable music playback devices, video processing devices, portable video processing devices, game devices, portable game devices, and household electrical products having displays.

What is claimed is:

1. A terminal device comprising:
a reception unit that receives an operation performed on a window by a hovering stylus pen;
an identification unit that, based on a position of the stylus pen and a position of the window when the operation is received, identifies an edge or a corner of the window that is to be an operation target of the stylus pen; and
an operation control unit that applies the operation performed by the stylus pen to the identified edge or corner.

2. The terminal device according to claim 1, wherein:
if the position of the stylus pen when the operation is received is near an edge or a corner of the window, then the identification unit identifies the nearby edge or corner of the window as the edge or the corner of the window that is to be the operation target of the stylus pen.

3. The terminal device according to claim 1, wherein:
if multiple windows are displayed when the operation is received, then the identification unit prefers an active window over an inactive window, and identifies the edge or the corner of the preferred window based on the position of the stylus pen and the position of the preferred window.

4. The terminal device according to claim 1, wherein:
if multiple windows are displayed so as to overlap when the operation is received, and there is no active window, then the identification unit, among the windows that are inactive, makes a window in the foreground active, and identifies the edge or the corner of the window that has been made active based on the position of the stylus pen and the position of the window that has been made active.

5. A computer readable non-transitory recording medium having a program recorded therein, the program causing a computer to execute:
a process for receiving an operation performed on a window by a hovering stylus pen;
a process for identifying, based on a position of the stylus pen and a position of the window when the operation is received, an edge or a corner of the window that is to be an operation target of the stylus pen; and
a process for applying the operation performed by the stylus pen to the identified edge or corner.

6. The recording medium according to claim 5, wherein:
if the position of the stylus pen when the operation is received is near an edge or a corner of the window, then the nearby edge or corner of the window is identified as the edge or the corner of the window that is to be the operation target of the stylus pen.

7. The recording medium according to claim 5, wherein:
if multiple windows are displayed when the operation is received, then an active window is preferred over an inactive window, and the edge or the corner of the preferred window is identified based on the position of the stylus pen and the position of the preferred window.

8. The recording medium according to claim 5, wherein:
if multiple windows are displayed so as to overlap when the operation is received, and there is no active window, then among the windows that are inactive, a window in the foreground is made active, and the edge or the corner of the window that has been made active is identified based on the position of the stylus pen and the position of the window that has been made active.
